(19) United States
(12) Patent Application Publication
(10) Pub. No.: US 2026/0270814 A1
(43) Pub. Date: Sep. 10, 2026

(54) TRIGGERING RACHLESS NETWORK INITIATED LTM

(71) Applicant: Samsung Electronics Co., Ltd., Suwon-si (KR)

(72) Inventors: Anil Agiwal, McKinney, TX (US); Kyeongin Jeong, Frisco, TX (US)

(21) Appl. No.: 19/537,163

(22) Filed: Feb. 11, 2026

Related U.S. Application Data
(60) Provisional application No. 63/767,709, filed on Mar. 6, 2025.
(60) Provisional application No. 63/814,721, filed on May 30, 2025.

(51) Int. Cl. H04W 36/00; H04W 36/08; H04W 36/30; H04W 56/00

(52) U.S. Cl. CPC H04W 36/00725; H04W 36/08; H04W 36/304; H04W 56/0045

(57) ABSTRACT

A method of operating a user equipment is provided that includes determining a first determination that a CLTM cell switch is triggered by an event. The method also includes, in response to the first determination, determining a second determination whether (i) the event is triggered by L1 measurements of a CLTM target cell, (ii) two timing advance groups are not configured for the CLTM target cell, (iii) a CG Type 1 configuration for a RACH-less cell switch procedure is configured for the CLTM target cell, and (iv) an ltm-Candidate-TimeAlignmentTimer is running in a first available CG occasion corresponding to an SSB or an SSB quasi-colocated with a selected channel state information-reference signal. The method further includes, in response to the second determination being affirmative, (i) processing a stored timing advance command associated with the ltm-Candidate-TimeAlignmentTimer, and (ii) considering RACH-less conditional LTM cell switch to be ongoing.

### CROSS-REFERENCE TO RELATED APPLICATION(S) AND CLAIM OF PRIORITY

This application claims priority under 35 U.S.C. § 119(e) to U.S. Provisional Patent Application No. 63/767,709 filed on Mar. 6, 2025, and U.S. Provisional Patent Application No. 63/814,721 filed on May 30, 2025. The above-identified provisional patent applications are hereby incorporated by reference in their entirety.

### TECHNICAL FIELD

This disclosure relates generally to wireless networks. More specifically, this disclosure relates to triggering random access channel (RACH)-less network initiated layer 1 (L1)/layer 2(L2) triggered mobility (LTM).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for triggering RACH-less network initiated LTM.

In one embodiment, a method of operating a user equipment (UE) is provided. The method includes, determining a first determination that a conditional layer 1 (L1)/layer 2(L2) triggered mobility (CLTM) cell switch is triggered by an event. The method also includes, in response to the first determination, determining a second determination whether (i) the event is triggered by L1 measurements of a CLTM target cell, (ii) two timing advance groups (TAGs) are not configured for the CLTM target cell, (iii) a configured grant (CG) Type 1 configuration for a RACH-less cell switch procedure is configured for the CLTM target cell, and (iv) an LTM candidate time alignment timer for the CLTM target cell (ltm-Candidate-TimeAlignmentTimer) is running in a first available CG occasion corresponding to a selected synchronization signal block (SSB) or an SSB quasi-colocated (QCLed) with a selected channel state information (CSI)-reference signal (RS). The method further includes, in response to the second determination being affirmative, (i) processing a stored timing advance (TA) command associated with the ltm-Candidate-TimeAlignmentTimer, and (ii) considering RACH-less conditional LTM cell switch to be ongoing.

In another embodiment, an electronic device is provided. The electronic device includes at least one processor including processing circuitry, and memory storing instructions. The instruction, when executed by the at least one processor individually or collectively, cause the electronic device to determine a first determination that a CLTM cell switch is triggered by an event. The instruction, when executed by the at least one processor individually or collectively, also cause the electronic device to, in response to the first determination, determine a second determination whether (i) the event is triggered by L1 measurements of a CLTM target cell, (ii) two TAGs are not configured for the CLTM target cell, (iii) a CG type 1 configuration for a RACH-less cell switch procedure is configured for the CLTM target cell, and (iv), an ltm-Candidate-TimeAlignmentTimer is funning for a first available CG occasion corresponding to a selected SSB or an SSB QCLed with a selected CSI-RS. The instruction, when executed by the at least one processor individually or collectively, further cause the electronic device to, in response to the second determination being affirmative, (i) process a stored TA command associated with the ltm-Candidate-TimeAlignmentTimer, and (ii) consider a RACH-less conditional LTM cell switch to be ongoing.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example NG-RAN overall architecture according to embodiments of the present disclosure;

FIG. 4B illustrates an example architecture for gNB-CU-CP and gNB-CU-UP separation according to embodiments of the present disclosure;

FIG. 5 illustrates example signaling procedures for inter-gNB handover according to embodiments of the present disclosure;

FIG. 6 illustrates an example procedure for triggering RACH-less network initiated LTM according to embodiments of the present disclosure;

FIGS. 7A and 7B illustrate an example procedure for a conditional RACH-less LTM cell switch according to embodiments of the present disclosure; and

FIG. 8 illustrates an example method for triggering RACH-less network initiated LTM according to embodiments of the present disclosure.

### DETAILED DESCRIPTION

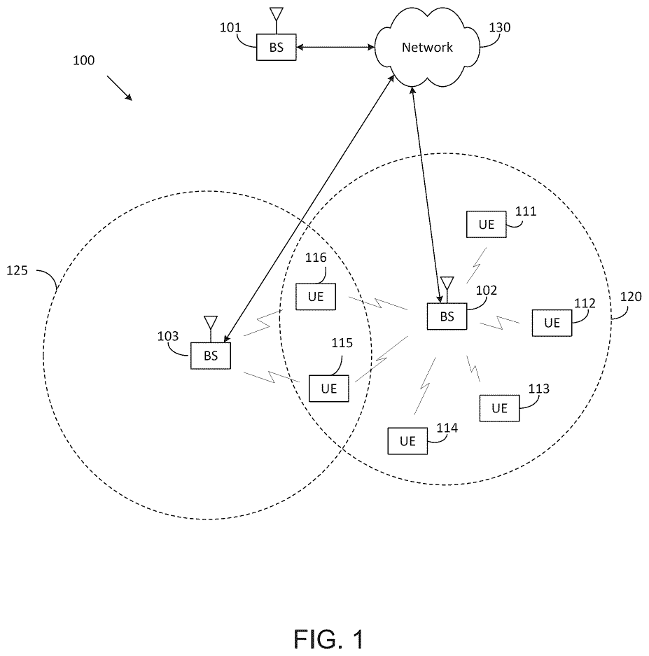

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for RACH-less network initiated LTM. In certain embodiments, one or more of the gNBs 101-103 includes circuitry, programing, or a combination thereof, to support a RACH-less network initiated LTM in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

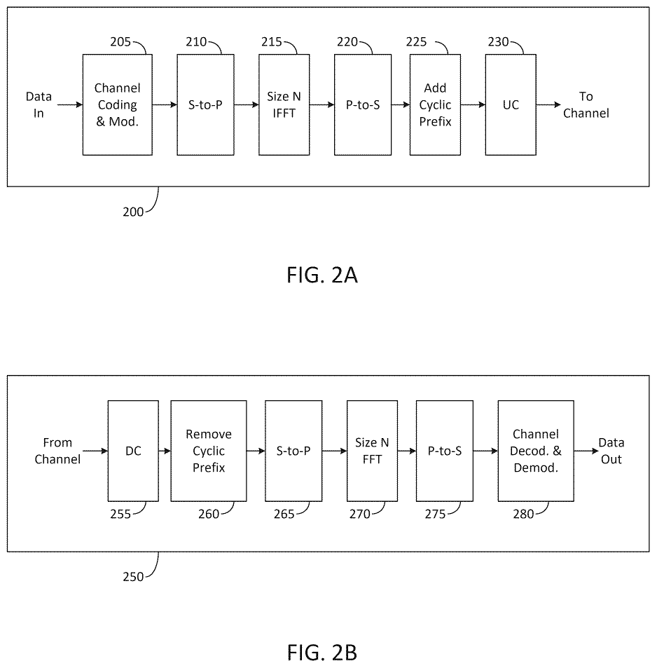

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support RACH-less network initiated LTM as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

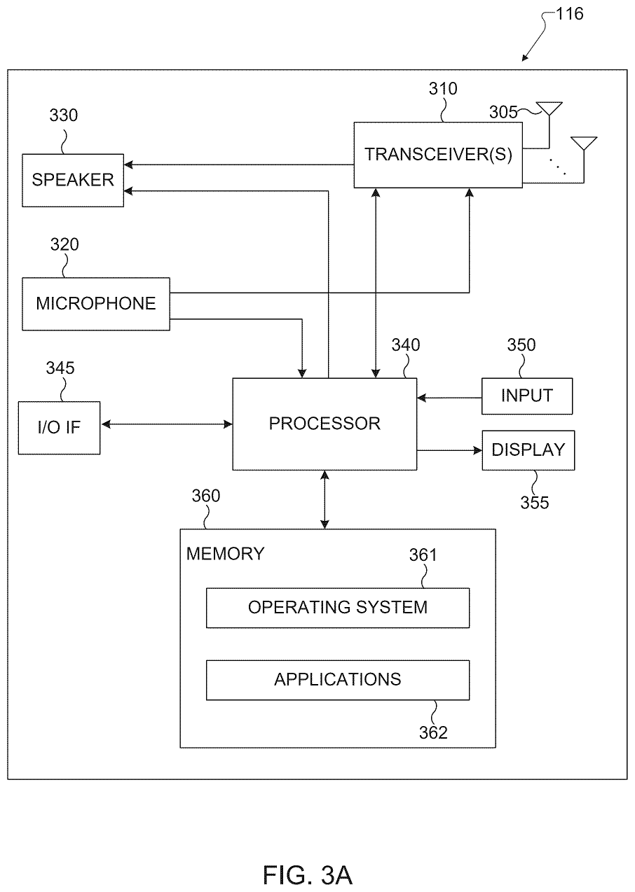

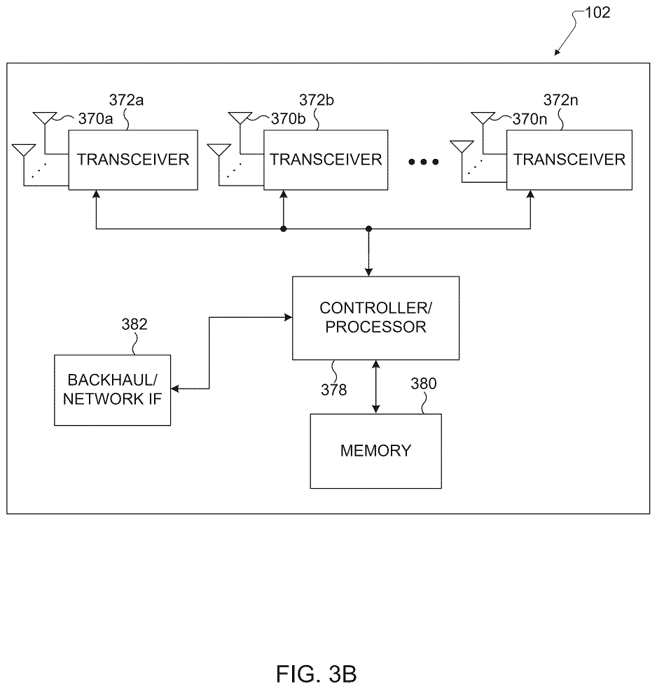

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for RACH-less network initiated LTM as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support RACH-less network initiated LTM as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+ duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot) =0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

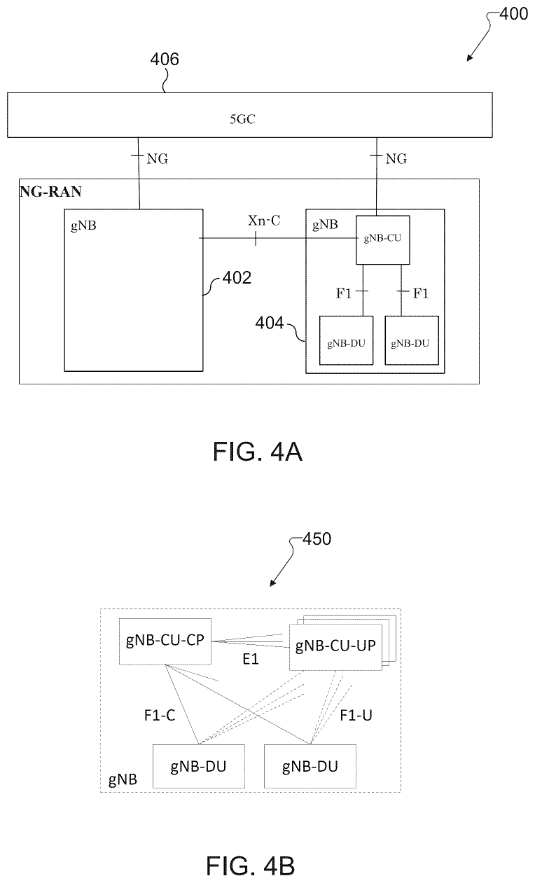

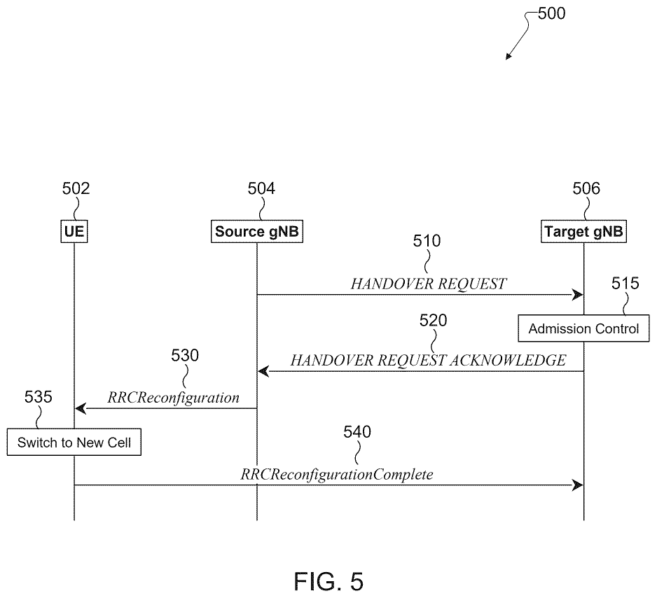

FIG. 4A illustrates an example next generation radio access network (NG-RAN) overall architecture 400 according to embodiments of the present disclosure. The embodiment of an NG-RAN overall architecture of FIG. 4A is for illustration only. Different embodiments of an NG-RAN overall architecture could be used without departing from the scope of this disclosure.

In the example of FIG. 4A, the NG-RAN comprises a set of gNBs 402 and 404 connected to the 5G core (5GC) 406 through NG interfaces. gNBs 402 and 404 can be interconnected through an Xn interface. A gNB may comprise a gNB-central unit (CU) and one or more gNB-distributed unit(s) (DU[s]). A gNB-CU and a gNB-DU are connected via an F1 interface. NG, Xn and F1 interfaces are logical interfaces.

Although FIG. 4A illustrates an example NG-RAN overall architecture 400, various changes may be made to FIG. 4A. For example, architecture 400 could include additional gNBs, different interfaces, etc. according to particular needs.

FIG. 4B illustrates an example architecture 450 for gNB-CU-control plane (CP) and gNB-CU-user plane (UP) separation according to embodiments of the present disclosure. The embodiment of gNB-CU-CP and gNB-CU-UP separation of FIG. 4B is for illustration only. Different embodiments of an architecture for gNB-CU-CP and gNB-CU-UP separation could be used without departing from the scope of this disclosure.

As shown in FIG. 4B, a gNB may comprise a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

Although FIG. 4B illustrates an example architecture 450 for gNB-CU-CP and gNB-CU-UP separation, various changes may be made to FIG. 450. For example, the gNB could include any number of UPs, DUs, etc. according to particular needs.

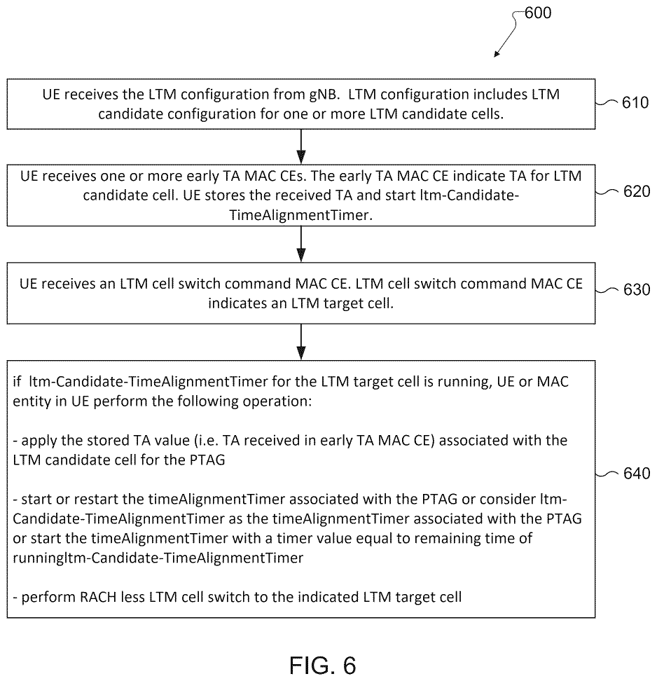

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 5.

FIG. 5 illustrates example signaling procedures 500 for inter-gNB handover according to embodiments of the present disclosure. An embodiment of the signaling procedures illustrated in FIG. 5 are for illustration only. One or more of the components illustrated in FIG. 5 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 5, source gNB 504 initiates handover and issues a HANDOVER REQUEST 510 over an Xn interface to a target gNB 506. Target gNB performs admission control at step 515 and provides a new RRC configuration as part of a HANDOVER REQUEST ACKNOWLEDGE 520. Source gNB 504 provides the RRC configuration to UE 502 by forwarding the RRCReconfiguration message 530 received in the HANDOVER REQUEST ACKNOWLEDGE 520. The RRCReconfiguration message 530 includes at least cell ID and all information required to access the target cell so that the UE 502 can access the target cell without reading system information. For some cases, the information required for contention-based and contention-free random access can be included in RRCReconfiguration message 530. The access information to the target cell may include beam specific information, if any. At step 535, UE 502 moves the RRC connection to target gNB 506 and replies with the RRCReconfigurationComplete message 540. The example of FIG. 5 may be referred to as a network controlled or network initiated handover procedure.

Although FIG. 5 illustrates one example of signaling procedures 500 for inter-gNB handover, various changes may be made to FIG. 5. For example, while shown as a series of steps, various steps in FIG. 5 could overlap, occur in parallel, occur in a different order, occur any number of times, be omitted, or replaced by other steps.

In addition to network controlled/network initiated handover, the next generation wireless communication system (e.g., 5G, beyond 5G, 6G) also supports conditional handover and dual active protocol stack (DAPS) handover. In the case of conditional handover, the network can configure one or more candidate cells for conditional handover and one or more L3 measurement based events based on which UE decides to perform a conditional handover procedure. In the case of DAPS handover, the UE continues the downlink user data reception from the source gNB until releasing the source cell and continues the uplink user data transmission to the source gNB until a successful random access procedure to the target gNB.

Layer one (L1)/layer two (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The LTM cell switch command MAC CE indicates an LTM candidate cell configuration that the gNB previously prepared and provided to the UE through RRC signaling. Then the UE switches to the target cell according to the cell switch command. This procedure is also referred as a network initiated LTM cell switch. For a network initiated LTM cell switch, the network can indicate the TA of the target cell in the LTM cell switch command MAC CE or the UE can estimate the TA of candidate cell itself. If the TA is received in the LTM cell switch command MAC CE or if the UE is configured with UE-based Timing Advance measurement and the UE has successfully measured the Timing Advance for the SpCell of the indicated LTM target configuration in the LTM cell switch command MAC CE, the UE performs a RACH-less LTM cell switch to target cell.

For LTM, the network may indicate one or more L1 measurement based events based on which the UE may initiate LTM execution to a candidate LTM cell without receiving a cell switch command from gNB. This procedure may be referred to as conditional LTM or UE initiated LTM.

In some embodiments, the network may request the UE to perform early TA acquisition of a candidate cell before a cell switch. The advantage here is that the UE need not perform a random access procedure when a cell switch to candidate cell is performed. A RACH-less cell switch reduces data interruption. The early TA acquisition can be triggered by a PDCCH order. The PDCCH order indicates one of the LTM candidate cells. In response, the UE initiates the random access procedure. Then the UE transmits a random access preamble to the indicated LTM candidate cell using the early UL synchronization configuration of that candidate cell. Upon transmission of the random access preamble, the random access procedure is considered completed. The Candidate cell determines the TA value based on received random access preamble. Then, the candidate cell or DU of the candidate cell sends the estimated TA to the gNB/DU (or source gNB/DU) of the serving cell. If the candidate cell is configured for UE initiated LTM cell switch, the gNB/DU (or source gNB/DU) of the serving cell may send the TA value in an early TA MAC CE to the UE after completion of the random access procedure. The early TA MAC CE indicates an LTM candidate cell identity (or Candidate Config ID) and a TA value. In some embodiments, the UE stores the received TA for the indicated candidate LTM cell and starts a timer ltm-Candidate-TimeAlignmentTimer for the LTM candidate cell indicated in the MAC CE. Later when a condition/criteria to trigger a conditional LTM cell switch to an LTM candidate cell is met at the UE and ltm-Candidate-TimeAlignmentTimer is running, the UE performs a RACH-less conditional LTM cell switch. Alternatively, in some embodiments, the UE stores the received TA for the indicated candidate LTM cell. The Candidate Config ID may indicate the index of the corresponding CLTM/LTM, corresponding to ltm-CandidateID minus 1 wherein each CLTM/LTM candidate configuration is identified by a ltm-CandidateID. The early TA MAC CE may also include a TAG ID (TI) field. If two TAGs are configured for the CLTM/LTM candidate cell corresponding to the Candidate Config ID, this field indicates one of the two TAGs to which the Timing Advance Command is applied. The field set to 0 indicates the tag 2-Id (second TAG) and the field set to 1 indicates the tag-Id (first TAG) of the CLTM/LTM candidate cell. If two TAGs are not configured for the CLTM/LTM candidate cell indicated by the latest PDCCH order before the UE receives this MAC CE, the R bit is present instead. The TAG ID corresponding to first and second TAG is signaled in the candidate configuration.

For a network initiated LTM cell switch, if TA is received in the LTM cell switch command MAC CE or if the UE is configured with UE-based Timing Advance measurement and the UE has successfully measured the Timing Advance for the SpCell of the indicated LTM target configuration in the LTM cell switch command MAC CE, the UE performs a RACH-less LTM cell switch to target cell.

Early TA may be signaled to the UE for a conditional LTM candidate cell using an early TA MAC CE. Later the network may send an LTM cell switch command MAC CE indicating the LTM candidate cell configuration of the conditional LTM candidate cell and without including TA in the LTM cell switch command MAC CE. In existing procedures, the UE will initiate a RACH based LTM cell switch to the SpCell of the indicated LTM target configuration in the LTM cell switch command MAC CE, as TA is not included in LTM cell switch command MAC CE and the UE also does not have a UE estimated TA. This is not an efficient operation and may increase LTM cell switch latency. Various embodiments of the present disclosure provide mechanisms for TA established by an early TA MAC CE for a conditional LTM candidate cell to be used for a network initiated LTM cell switch to the same LTM candidate cell.

In existing procedures, when an event to perform an LTM cell switch to an LTM candidate cell is met, the UE selects an SSB or CSI-RS. If the event for conditional LTM is satisfied based on L1 measurements, the UE may select the SSB or CSI-RS of the candidate cell for which the event is met. If the event for conditional LTM is satisfied based on L3 measurements and if a configured grant Type 1 configuration for RACH-less CLTM/LTM cell switch procedure is configured for the candidate cell and if a synchronization signal reference signal received power (SS-RSRP) of at least one SSB associated with this configured grant Type 1 configuration is above a threshold cg-LTM-RSRP-ThresholdSSB. the UE selects an SSB amongst the SSBs associated with this configured grant Type 1 configuration with SS-RSRP above cg-LTM-RSRP-ThresholdSSB.

If the ltm-Candidate-TimeAlignmentTimer associated with the candidate cell is running in the first available CG occasion, in cases where two TAGs are not configured for the candidate cell, the UE considers the RACH-less CLTM cell switch to be ongoing.

If the ltm-Candidate-TimeAlignmentTimer or ltm-Candidate-TimeAlignmentTimerTAG2 associated with the with the candidate cell for the TAG associated with the selected SSB or selected CSI-RS is running in the first available CG occasion in cases where two TAGs are configured for the candidate cell, the UE considers the RACH-less CLTM cell switch to be ongoing.

If the UE is configured with UE-based Timing Advance measurement and the UE has successfully measured the Timing Advance for the candidate cell in the first available CG occasion, the UE considers the RACH-less CLTM cell switch to be ongoing.

An issue with the existing operation to determine a RACH-less CLTM cell switch is that the first available CG occasion may not correspond to an SSB with an SS-RSRP above cg-LTM-RSRP-ThresholdSSB. As a result, TA may be valid at the first available CG occasion but it may not be valid at the first CG occasion which the UE is going to use for UL transmission to the candidate cell. Various embodiments of the present disclosure provide mechanisms to overcome this issue.

Another issue with the existing operation to determine a RACH-less CLTM cell switch is that there is no mapping between an SSB/CSI RS and a TAG. Therefore, the UE cannot know which TAG is associated with the selected SSB or selected CSI-RS in cases where the candidate cell is associated with two TAGs. Various embodiments of the present disclosure provide mechanisms to overcome this issue.

Another issue with the existing operation to determine a RACH-less CLTM cell switch is that the UEs select an SSB with SS-RSRP above cg-LTM-RSRP-ThresholdSSB. It is possible that the SSB's SS-RSRP is above cg-LTM-RSRP-ThresholdSSB but the TA which the UE has is not applicable to this SSB and as a result a RACH-less CLTM cell switch cannot be performed. Various embodiments of the present disclosure provide mechanisms to overcome this issue.

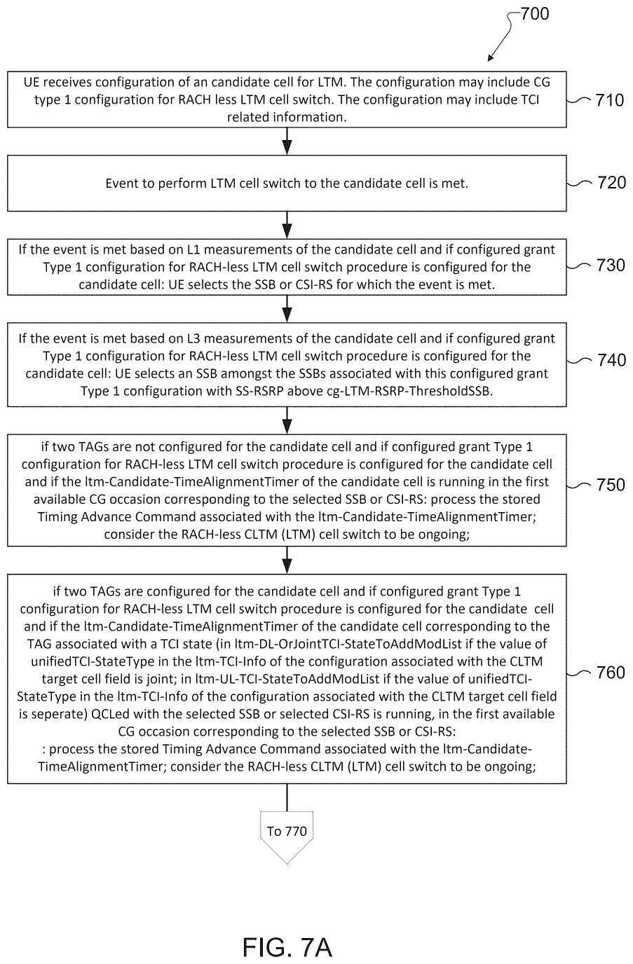

FIG. 6 illustrates an example procedure for triggering RACH-less network initiated LTM 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for triggering RACH-less network initiated LTM could be used without departing from the scope of this disclosure.

In the example of FIG. 6, the procedure 600 begins at step 610. At step 610, a UE (such as UE 116 of FIG. 1) receives an LTM configuration from a gNB (such as gNB 102 of FIG. 1). For example, the LTM configuration can be received in an RRCReconfiguration message. The LTM configuration includes an LTM candidate configuration for one or more LTM candidate cells. The LTM candidate configuration also includes early an UL synchronization configuration for NUL and/or SUL. The UE stores the received configuration and an some embodiments transmits an RRCReconfigurationComplete message to the gNB. The LTM configuration may include criteria/events/conditions for the UE initiated LTM cell switch for one or more LTM candidate cells.

At operation 620, the UE receives a PDCCH order from the source cell (serving cell). The PDCCH order indicates one of the LTM candidate cells. In response, the UE initiates a random access procedure, and transmits a random access preamble to the indicated LTM candidate cell using the early UL synchronization configuration of that candidate cell. Upon transmission of the random access preamble, the random access procedure is considered completed. The candidate cell determines a TA value based on received random access preamble. Then the candidate cell or DU of the candidate cell sends the estimated TA to the gNB/DU (or source gNB/DU) of the serving cell. If the candidate cell is configured for UE initiated LTM cell switch, the gNB/DU (or source gNB/DU) of serving cell may send the TA value in an early TA MAC CE to UE. The early TA MAC CE indicates an LTM candidate cell identity and TA value. This operation can be performed for one or more LTM candidate cell for which UE initiated LTM is supported. In response, the UE stores the received TA for the indicated candidate LTM cell, and starts an ltm-Candidate-TimeAlignmentTimer for the LTM candidate cell indicated in the MAC CE. The ltm-Candidate-TimeAlignmentTimer for LTM candidate cell can be signaled (e.g., in an early UL synchronization configuration or LTM configuration) by the gNB for the delivered TA.

In some embodiments, at operation 630, the UE may receive an LTM cell switch command MAC CE. The LTM cell switch command MAC CE indicates an LTM target cell. Upon receiving the LTM cell switch command MAC CE (or upon receiving the LTM cell switch command MAC CE not including TA or upon receiving the LTM cell switch command MAC CE with a Timing Advance Command value set to FFF), at operation 640 the UE checks if an ltm-Candidate-TimeAlignmentTimer for the LTM target cell is running. If an ltm-Candidate-TimeAlignmentTimer for the LTM target cell is running, the UE or the MAC entity in the UE performs the following operations:
application of the stored TA value (i.e., TA received in early TA MAC CE) associated with the LTM candidate cell for the PTAG
starting or restarting of the timeAlignmentTimer associated with the PTAG or considering ltm-Candidate-TimeAlignmentTimer as the timeAlignmentTimer associated with the PTAG or starting the timeAlignmentTimer with a timer value equal to the remaining time of a running ltm-Candidate-TimeAlignmentTimer
performance of a RACH-less LTM cell switch to the indicated LTM target cell.

Alternatively, in some embodiments, at operation 630 the UE receives an LTM cell switch command MAC CE. The LTM cell switch command MAC CE includes a Target Configuration ID field. This field indicates the index of a candidate target configuration to apply for an LTM cell switch, corresponding to ltm-CandidateId minus 1. The ltm-CandidateId is signaled in each LTM candidate configuration. For example, if an ltm-CandidateId in an LTM candidate configuration is X, the Target Configuration ID in the MAC CE will be set to X−1. Upon receiving the LTM cell switch command MAC CE (or upon receiving the LTM cell switch command MAC CE not including TA or upon receiving the LTM cell switch command MAC CE with a Timing Advance Command value set to FFF), at operation 640 the UE or MAC entity in the UE checks if an ltm-Candidate-TimeAlignmentTimer for the target cell/SpCell of the indicated/corresponding Target Configuration ID is running. If the ltm-Candidate-TimeAlignmentTimer for the target cell/SpCell of the indicated/corresponding Target Configuration ID is running, the UE or MAC entity in the UE performs the following operations:
processing of the stored TA value (i.e., TA received in early TA MAC CE) associated with the target cell;
   when an LTM Cell Switch Command MAC CE is received, and the Timing Advance Command in the MAC CE is set as FFF, and the ltm-Candidate-TimeAlignmentTimer for the target cell indicated by Target Configuration ID is running:
      application of the stored TA value (i.e., the TA received in the early TA MAC CE) associated with the LTM candidate cell for the PTAG;
      starting or restarting of the timeAlignmentTimer associated with the PTAG.
consideration of the RACH-less LTM cell switch to be ongoing.
if the MAC entity is associated with the SCG:
   indication to upper layers (i.e., RRC) to skip the Random Access procedure for this LTM cell switch.

Although FIG. 6 illustrates one example procedure for triggering RACH-less network initiated LTM 600, various changes may be made to FIG. 6. For example, while shown as a series of operations, various operations in FIG. 6 could overlap, occur in parallel, occur in a different order, occur any number of times, be omitted, or replaced by other operations.

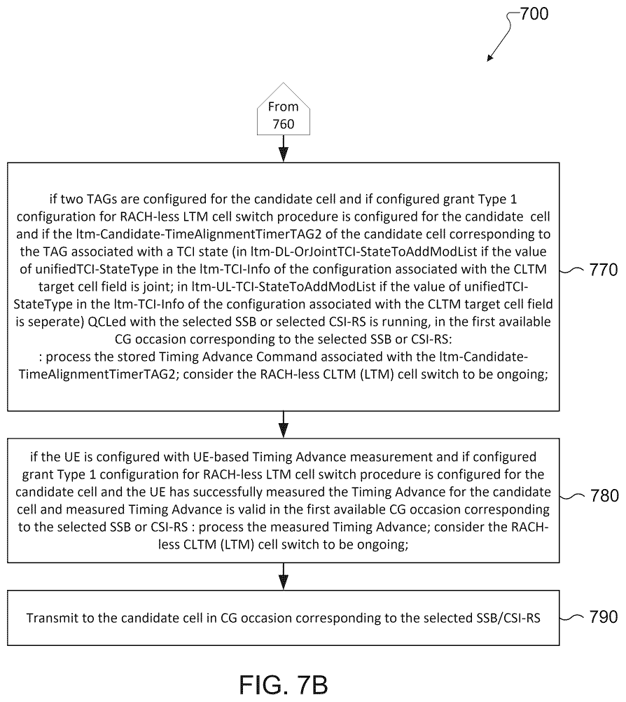

FIGS. 7A and 7B illustrate an example procedure for a conditional RACH-less LTM cell switch 700 according to embodiments of the present disclosure. An embodiment of the procedure illustrated in FIGS. 7A and 7B is for illustration only. One or more of the components illustrated in FIGS. 7A and 7B may be implemented in specialized circuitry configured to perform the noted functions or one or more of the components may be implemented by one or more processors executing instructions to perform the noted functions. Other embodiments of a procedure for a conditional RACH-less LTM cell switch could be used without departing from the scope of this disclosure.

In the example of FIG. 7, the procedure 700 begins at step 710. At step 710, a UE (such as UE 116 of FIG. 1) receives a configuration of a candidate cell for LTM. The candidate configuration is identified by a ltm-CandidateID. The configuration may include configured grant type 1 configuration for a RACH-less CLTM/LTM cell switch. The configured grant type 1 configuration configures configured UL grants/occasions occurring periodically. The configured grant type 1 configuration may be associated with SSB(s) transmitted in the candidate cell. Each configured UL grant/occasion can be associated with one or more SSBs. The configuration may include TCI related information. The TCI related information may include ltm-DL-OrJointTCI-StateToAddModList (list of DL or joint TCI states), ltm-UL-TCI-StateToAddModList (list of UL TCI states) and unifiedTCI-StateType. unifiedTCI-StateType indicates the unified TCI states type the UE is configured for this LTM candidate configuration. The value separate in unifiedTCI-StateType means this LTM candidate configuration is configured with ltm-DL-OrJointTCI-StateToAddModList for DL TCI states and ltm-UL-TCI-StateToAddModList for UL TCI states. The value joint in unifiedTCI-StateType means this LTM candidate configuration is configured with ltm-DL-OrJointTCI-StateToAddModList for joint TCI states for UL and DL operation. The configuration may further include L1 or L3 based LTM execution conditions.

At operation 720, an event to perform LTM cell switch to the candidate cell (which can also be referred to as a CLTM target cell) is met based on the configured L1 or L3 based LTM execution conditions.

At operation 730, if the event is met based on L1 measurements of the candidate cell (CLTM/LTM target cell) and if configured grant Type 1 configuration for RACH-less CLTM/LTM cell switch procedure is configured for the candidate cell (CLTM/LTM target cell), the UE selects the SSB or CSI-RS for which the event is met. For an L1 based LTM execution condition, an LTM-CSI-ReportConfig may be indicated. The LTM-CSI-ReportConfig includes an LTM-CSI-ResourceConfig which indicates one or more SSB-Indexes or NZP-CSI-RS-ResourceIDs to be measured.

In some embodiments, At operation 740, if the event is met based on L3 measurements of the candidate cell (CLTM/LTM target cell) and if configured grant Type 1 configuration for RACH-less CLTM/LTM cell switch procedure is configured for the candidate cell (CLTM/LTM target cell), the UE selects an SSB with an SS-RSRP above a threshold (e.g., cg-LTM-RSRP-ThresholdSSB configured in the candidate configuration) amongst the SSBs associated with this configured grant Type 1 configuration.

Alternatively, in some embodiments, at operation 740, if the event for conditional LTM is satisfied based on L3 measurements and if a configured grant Type 1 configuration for RACH-less CLTM/LTM cell switch procedure is configured for the candidate cell (or a CLTM target cell i.e., the SpCell corresponding to the target configuration indicated by Target Configuration ID where the Target Configuration ID is ltm-CandidateID minus 1), if two TAGs are configured for the candidate cell (or CLTM target cell) and if the ltm-Candidate-TimeAlignmentTimer/ltm-Candidate-TimeAlignmentTimerTAG2 of the candidate cell (or CLTM target cell) is running and an SS-RSRP of an SSB QCLed with a TCI state (in ltm-DL-OrJointTCI-StateToAddModList if the value of unifiedTCI-StateType in the ltm-TCI-Info of the configuration associated with the CLTM target cell field is joint; in ltm-UL-TCI-StateToAddModList if the value of unifiedTCI-StateType in the ltm-TCI-Info of the configuration associated with the CLTM target cell field is seperate) of the TAG associated with ltm-Candidate-TimeAlignmentTimer/ltm-Candidate-TimeAlignmentTimerTAG2 is above cg-LTM-RSRP-ThresholdSSB and this SSB is also associated with configured grant Type 1 configuration for RACH-less CLTM/LTM cell switch procedure, the UE selects the SSB. Otherwise, if two TAGs are not configured for the candidate cell (or CLTM target cell), if an SS-RSRP of at least one SSB associated with configured grant Type 1 configuration is above the cg-LTM-RSRP-ThresholdSSB, the UE selects an SSB amongst the SSBs associated with this configured grant Type 1 configuration with SS-RSRP above cg-LTM-RSRP-ThresholdSSB.

At operation 750, if multiple TAGs (e.g., the number of TAGs can be two) are not configured for the candidate cell (CLTM/LTM target cell) and if configured grant Type 1 configuration for RACH-less CLTM/LTM cell switch procedure is configured for the candidate cell (CLTM/LTM target cell) and if the ltm-Candidate-TimeAlignmentTimer of the candidate cell (CLTM/LTM target cell) is running in (or at) the first available CG occasion (the CG occasion is determined based on the Configured grant type 1 configuration for a RACH-less LTM cell switch) corresponding to the selected SSB or SSB QCLed with selected CSI-RS, the UE processes the stored Timing Advance Command associated with the ltm-Candidate-TimeAlignmentTimer (i.e., the UE applies this TA for UL transmission to the candidate cell [CLTM/LTM target cell], considers the RACH-less CLTM (LTM) cell switch to be ongoing.

At operation 760, if multiple TAGs (e.g., the number of TAGs can be two) are configured for the candidate cell and if a configured grant Type 1 configuration for RACH-less LTM cell switch procedure is configured for the candidate cell and if the ltm-Candidate-TimeAlignmentTimer of the candidate cell corresponding to the TAG associated with a TCI state (in ltm-DL-OrJointTCI-StateToAddModList included in the configuration of the candidate cell, if the value of unifiedTCI-StateType in the ltm-TCI-Info of the configuration associated with the candidate cell field is joint; in ltm-UL-TCI-StateToAddModList included in the configuration of the candidate cell if the value of unifiedTCI-StateType in the ltm-TCI-Info of the configuration associated with the candidate cell field is seperate) QCLed with the selected SSB or selected CSI-RS is running, in the first available CG occasion corresponding to the selected SSB or CSI-RS, the UE processes the stored Timing Advance Command associated with the ltm-Candidate-TimeAlignmentTimer (i.e., the UE applies this TA for UL transmission to the candidate cell [CLTM/LTM target cell]) and considers the RACH-less CLTM (LTM) cell switch to be ongoing.

At operation 770, if multiple TAGs (e.g., the number of TAGs can be two) are configured for the candidate cell and if a configured grant Type 1 configuration for RACH-less LTM cell switch procedure is configured for the candidate cell and if the ltm-Candidate-TimeAlignmentTimerTAG2 of the candidate cell corresponding to the TAG associated with a TCI state (in ltm-DL-OrJointTCI-StateToAddModList included in the configuration of the candidate cell, if the value of unifiedTCI-StateType in the ltm-TCI-Info of the configuration associated with the candidate cell field is joint; in ltm-UL-TCI-StateToAddModList included in the configuration of the candidate cell if the value of unifiedTCI-StateType in the ltm-TCI-Info of the configuration associated with the candidate cell field is seperate) QCLed with the selected SSB or selected CSI-RS is running, in the first available CG occasion corresponding to the selected SSB or CSI-RS, the UE processes the stored Timing Advance Command associated with the ltm-Candidate-TimeAlignmentTimer TAG2 (i.e., the UE applies this TA for UL transmission to the candidate cell [CLTM/LTM target cell]) and considers the RACH-less CLTM (LTM) cell switch to be ongoing.

Note that, if a tag-id-ptr associated with a TCI state QCLed with the selected SSB or selected CSI-RS is set to n0, the timer associated with the TAG of the TCI state is ltm-Candidate-TimeAlignmentTimer. If the tag-id-ptr associated with a TCI state QCLed with the selected SSB or selected CSI-RS is set to n1, the timer associated with the TAG of the TCI state is ltm-Candidate-TimeAlignmentTimerTAG2.

At operation 780, if the UE is configured with a UE-based Timing Advance measurement and if configured grant Type 1 configuration for RACH-less CLTM/LTM cell switch procedure is configured for the candidate cell (CLTM/LTM target cell)and the UE has successfully measured the Timing Advance for the candidate cell (CLTM/LTM target cell) and the measured Timing Advance is valid in the first available CG occasion corresponding to the selected SSB or CSI-RS, the UE processes the measured Timing Advance (i.e., the UE applies this TA for UL transmission to the candidate cell [CLTM/LTM target cell]), and considers the RACH-less CLTM (LTM) cell switch to be ongoing.

At operation 790, the UE transmits to the candidate cell (CLTM/LTM target cell) in a CG occasion corresponding to the selected SSB/CSI-RS. The transmission may include an RRCReconfiguration complete message.

In some embodiments, if multiple TAGs (e.g., the number of TAGs can be two) are configured for the candidate cell and if a configured grant Type 1 configuration for RACH-less LTM cell switch procedure is configured for the candidate cell and if the ltm-Candidate-TimeAlignmentTimer or ltm-Candidate-TimeAlignmentTimerTAG2 of the candidate cell corresponding to the TAG associated with a TCI state (in ltm-DL-OrJointTCI-StateToAddModList included in the configuration of the candidate cell, if the value of unifiedTCI-StateType in the ltm-TCI-Info of the configuration associated with the candidate cell field is joint; in ltm-UL-TCI-StateToAddModList included in the configuration of the candidate cell if the value of unifiedTCI-StateType in the ltm-TCI-Info of the configuration associated with the candidate cell field is seperate) QCLed with the selected SSB or selected CSI-RS is running, in the first available CG occasion corresponding to the selected SSB or CSI-RS, the UE processes the stored Timing Advance Command associated with the ltm-Candidate-TimeAlignmentTimer or ltm-Candidate-TimeAlignmentTimerTAG2 (i.e., the UE applies this TA for UL transmission to the candidate cell [CLTM/LTM target cell]) and considers the RACH-less CLTM (LTM) cell switch to be ongoing.

Although FIGS. 7A and 7B illustrate one example procedure for a conditional RACH-less LTM cell switch 700, various changes may be made to FIGS. 7A and 7B. For example, while shown as a series of operations, various operations in FIGS. 7A and 7B could overlap, occur in parallel, occur in a different order, occur any number of times, be omitted, or replaced by other operations.

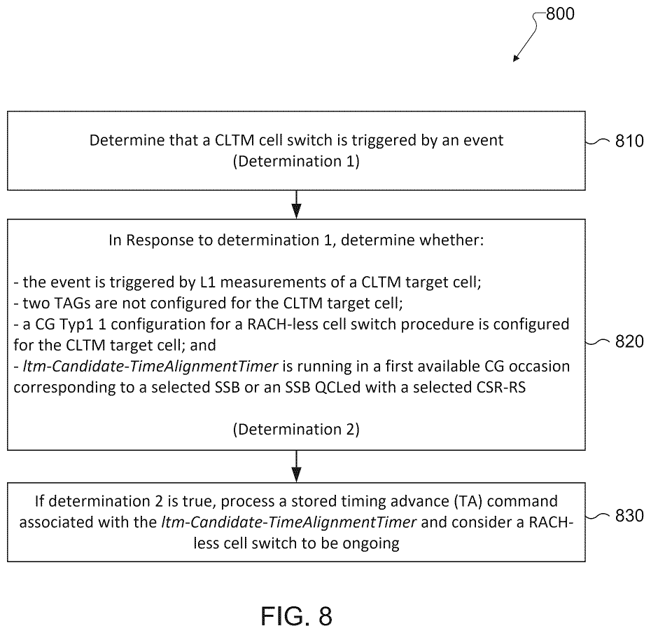

FIG. 8 illustrates an example method for triggering RACH-less network initiated LTM 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for triggering RACH-less network initiated LTM could be used without departing from the scope of this disclosure.

In the example of FIG. 8, the procedure 800 begins at step 810. At step 810, a UE (such as UE 116 of FIG. 1) determines that a CLTM cell switch is triggered by an event. This determination may be referred to as a “first determination” or “determination 1”.

At operation 820, in response to the first determination, the UE may perform another determination (which may be referred to as a “second determination” or “determination 2”) whether (i) the event is triggered by L1 measurements of a CLTM target cell, (ii) two TAGs are not configured for the CLTM target cell, (iii) a CG Type 1 configuration for a RACH-less cell switch is configured for the CLTM target cell, and (iv) an ltm-Candidate-TimeAlignmentTimer is running in a first available CG occasion corresponding to a selected SSB or an SSB QCLed with a selected CSI-RS.

At operation 830, in response to the second determination being affirmative, the UE processes a stored TA command associated with the ltm-Candidate-TimeAlignmentTimer, and considers RACH-less conditional LTM cell switch to be ongoing.

In some embodiments, the selected SSB or CSI-RS may be an SSB or CSI-RS for which the event was triggered.

In some embodiments, the UE may further determine another determination (which may be referred to as a “third determination” or “determination 3”) whether (i) the event is triggered by L1 measurements of the CLTM target cell, (ii) two TAGs are configured for the CLTM target cell, (iii) a CG Type 1 configuration for a random access channel RACH-less cell switch procedure is configured for the CLTM target cell, and a ltm-Candidate-TimeAlignmentTimer or a ltm-Candidate-TimeAlignmentTimerTAG2 of the CLTM target cell corresponding to a TAG associated with a TCI state QCLed with a selected SSB or selected CSI-RS is running in a first available CG occasion corresponding to the selected SSB or SSB QCLed with the selected CSI-RS. In response to the third determination being affirmative, the UE may process the stored TA command associated with the ltm-Candidate-TimeAlignmentTimer or ltm-Candidate-TimeAlignmentTimerTAG2, and consider the RACH-less conditional LTM cell switch to be ongoing. In embodiments such as these, the selected SSB or CSI-RS may be an SSB or CSI-RS for which the event was triggered.

In some embodiments, the UE may further determine another determination (which may be referred to as a “third determination” or “determination 3”) whether (i) the event is triggered by L1 measurements of the CLTM target cell, (ii) the UE is configured with UE-based TA measurement, (iii) the UE has successfully measured a TA for the CLTM target cell, and (iv) the measured TA is valid in a first available CG occasion corresponding to the selected SSB or CSI-RS. In response to the third determination being affirmative, the UE may process the stored TA command associated with the ltm-Candidate-TimeAlignmentTimer, and consider the RACH-less conditional LTM cell switch to be ongoing. In embodiments such as these, the selected SSB or CSI-RS may be an SSB or CSI-RS for which the event was triggered.

In some embodiments, the UE may further determine another determination (which may be referred to as a “third determination” or “determination 3”) whether (i) the event is triggered by L3 measurements of the CLTM target cell, (ii) two TAGs are not configured for the CLTM target cell, (iii) a CG Type 1 configuration for a RACH-less cell switch is configured for the CLTM target cell, and (iv) an ltm-Candidate-TimeAlignmentTimer is running in a first available CG occasion corresponding to a selected SSB. In response to the third determination being affirmative, the UE may process the stored TA command associated with the ltm-Candidate-TimeAlignmentTimer, and consider the RACH-less conditional LTM cell switch to be ongoing. In embodiments such as these, the selected SSB may be an SSB with an SS-RSRP above a cg-LTM-RSRP-ThresholdSSB amongst a plurality of SSBs associated with the CG Type 1 configuration.

In some embodiments, the UE may further determine another determination (which may be referred to as a “third determination” or “determination 3”) whether (i) the event is triggered by L3 measurements of the CLTM target cell, (ii) two TAGs are configured for the CLTM target cell, (iii) a CG Type 1 configuration for a random access channel RACH-less cell switch procedure is configured for the CLTM target cell, and a ltm-Candidate-TimeAlignmentTimer or a ltm-Candidate-TimeAlignmentTimerTAG2 of the CLTM target cell corresponding to a TAG associated with a TCI state QCLed with a selected SSB or selected CSI-RS is running in a first available CG occasion corresponding to the selected SSB or SSB QCLed with the selected CSI-RS. In response to the third determination being affirmative, the UE may process the stored TA command associated with the ltm-Candidate-TimeAlignmentTimer or ltm-Candidate-TimeAlignmentTimerTAG2, and consider the RACH-less conditional LTM cell switch to be ongoing. In embodiments such as these, the selected SSB may be an SSB with an SS-RSRP above a cg-LTM-RSRP-ThresholdSSB amongst a plurality of SSBs associated with the CG Type 1 configuration, and may be associated with the TCI state of the TAG for which ltm-Candidate-TimeAlignmentTimer or ltm-Candidate-TimeAlignmentTimerTAG2 is running.

Although FIG. 8 illustrates one example method for triggering RACH-less network initiated LTM 800, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
determining a first determination that a conditional layer 1 (L1)/layer 2(L2) triggered mobility (CLTM) cell switch is triggered by an event;
in response to the first determination, determining a second determination whether:
the event is triggered by L1 measurements of a CLTM target cell;
two timing advance groups (TAGs) are not configured for the CLTM target cell;
a configured grant (CG) Type 1 configuration for a random access channel (RACH)-less cell switch procedure is configured for the CLTM target cell; and
an LTM candidate time alignment timer for the CLTM target cell (ltm-Candidate-TimeAlignmentTimer) is running in a first available CG occasion corresponding to a selected synchronization signal block (SSB) or an SSB quasi-colocated (QCLed) with a selected channel state information (CSI)-reference signal (RS); and
in response to the second determination being affirmative:
processing a stored timing advance (TA) command associated with the ltm-Candidate-TimeAlignmentTimer; and
considering RACH-less conditional LTM cell switch to be ongoing.

2. The method of claim 1, wherein the selected SSB or CSI-RS is an SSB or CSI-RS for which the event was triggered.

3. The method of claim 1, further comprising:
determining a third determination whether:
the event is triggered by L1 measurements of the CLTM target cell;
two TAGs are configured for the CLTM target cell;
a CG Type 1 configuration for a RACH-less cell switch procedure is configured for the CLTM target cell; and
a first LTM candidate time alignment timer (ltm-Candidate-TimeAlignmentTimer) or a second LTM candidate time alignment timer (ltm-Candidate-TimeAlignmentTimerTAG2) of the CLTM target cell corresponding to a TAG associated with a transmission configuration indicator (TCI) state QCLed with a selected SSB or selected CSI-RS is running in a first available CG occasion corresponding to the selected SSB or SSB QCLed with the selected CSI-RS; and
in response to the third determination being affirmative:
processing the stored TA command associated with the ltm-Candidate-TimeAlignmentTimer or the ltm-Candidate-TimeAlignmentTimerTAG2; and
considering the RACH-less conditional LTM cell switch to be ongoing.

4. The method of claim 3, wherein the selected SSB or CSI-RS is an SSB or CSI-RS for which the event was triggered.

5. The method of claim 1, further comprising:
determining a third determination whether:
the event is triggered by L1 measurements of the CLTM target cell;
the UE is configured with UE-based TA measurement;
the UE has successfully measured a TA for the CLTM target cell;
the measured TA is valid in a first available CG occasion corresponding to the selected SSB or CSI-RS; and
in response to the third determination being affirmative:
processing the stored TA command associated with the ltm-Candidate-TimeAlignmentTimer; and
considering the RACH-less conditional LTM cell switch to be ongoing.

6. The method of claim 5, wherein the selected SSB or CSI-RS is an SSB or CSI-RS for which the event was triggered.

7. The method of claim 1, further comprising:
determining a third determination whether:
the event is triggered by layer 3 (L3) measurements of the CLTM target cell;
two TAGs are not configured for the CLTM target cell;
a CG Type 1 configuration for a RACH-less cell switch procedure is configured for the CLTM target cell; and
ltm-Candidate-TimeAlignmentTimer is running in a first CG occasion corresponding to a selected SSB and
in response to the third determination being affirmative:
processing the stored TA command associated with the ltm-Candidate-TimeAlignmentTimer; and
considering the RACH-less conditional LTM cell switch to be ongoing.

8. The method of claim 7, wherein the selected SSB is an SSB with a synchronization signal reference signal received power (SS-RSRP) above a threshold cg-LTM-RSRP-ThresholdSSB amongst a plurality of SSBs associated with the CG Type 1 configuration.

9. The method of claim 1, further comprising:
determining a third determination whether:
the event is triggered by layer 3 (L3) measurements of the CLTM target cell;
two TAGs are configured for the CLTM target cell;
a CG Type 1 configuration for a random access channel (RACH)-less cell switch procedure is configured for the CLTM target cell; and
a first LTM candidate time alignment timer (ltm-Candidate-TimeAlignmentTimer) or a second LTM candidate time alignment timer (ltm-Candidate-TimeAlignmentTimerTAG2) of the CLTM target cell corresponding to a TAG associated with a transmission configuration indicator (TCI) state QCLed with the selected SSB or selected CSI-RS is running in a first available CG occasion corresponding to the selected SSB or SSB QCLed with the selected CSI-RS; and
in response to the third determination being affirmative:
processing the stored TA command associated with the ltm-Candidate-TimeAlignmentTimer or the ltm-Candidate-TimeAlignmentTimerTAG2; and
considering the RACH-less conditional LTM cell switch to be ongoing.

10. The method of claim 9, wherein the selected SSB is an SSB with a synchronization signal reference signal received power (SS-RSRP) above a threshold cg-LTM-RSRP-ThresholdSSB amongst a plurality of SSBs associated with the CG Type 1 configuration, and is associated with the TCI state of the TAG for which ltm-Candidate-TimeAlignmentTimer or ltm-Candidate-TimeAlignmentTimerTAG2 is running.

11. An electronic device comprising:
at least one processor including processing circuitry; and
memory storing instructions, wherein the instructions, when executed by the at least one processor individually or collectively, cause the electronic device to:
determine a first determination that a conditional layer 1 (L1)/layer 2(L2) triggered mobility (CLTM) cell switch is triggered by an event;
in response to the first determination, determine a second determination whether:
the event is triggered by L1 measurements of a CLTM target cell;
two timing advance groups (TAGs) are not configured for the CLTM target cell;
a configured grant (CG) Type 1 configuration for a random access channel (RACH)-less cell switch procedure is configured for the CLTM target cell; and
an LTM candidate time alignment timer for the CLTM target cell (ltm-Candidate-TimeAlignmentTimer) is running in a first available CG occasion corresponding to a selected synchronization signal block (SSB) or an SSB quasi-colocated (QCLed) with a selected channel state information (CSI)-reference signal (RS); and
in response to the second determination being affirmative:
process a stored timing advance (TA) command associated with the ltm-Candidate-TimeAlignmentTimer; and
consider a RACH-less conditional LTM cell switch to be ongoing.

12. The electronic device of claim 11, wherein the selected SSB or CSI-RS is an SSB or CSI-RS for which the event was triggered.

13. The electronic device of claim 11, wherein the instructions, when executed by the at least one processor individually or collectively, further cause the electronic device to:
determine a third determination whether:
the event is triggered by L1 measurements of the CLTM target cell;
two TAGs are configured for the CLTM target cell;
a CG Type 1 configuration for a random access channel (RACH)-less cell switch procedure is configured for the CLTM target cell; and
a first LTM candidate time alignment timer (ltm-Candidate-TimeAlignmentTimer) or a second LTM candidate time alignment timer (ltm-Candidate-TimeAlignmentTimerTAG2) of the CLTM target cell corresponding to a TAG associated with a transmission configuration indicator (TCI) state QCLed with a selected SSB or selected CSI-RS is running in a first available CG occasion corresponding to the selected SSB or SSB QCLed with the selected CSI-RS; and
in response to the third determination being affirmative:
process the stored TA command associated with the ltm-Candidate-TimeAlignmentTimer or ltm-Candidate-TimeAlignmentTimerTAG2; and
consider the RACH-less conditional LTM cell switch to be ongoing.

14. The electronic device of claim 13, wherein the selected SSB or CSI-RS is an SSB or CSI-RS for which the event was triggered.

15. The electronic device of claim 11, wherein the instructions, when executed by the at least one processor individually or collectively, further cause the electronic device to:
determining a third determination whether:
the event is triggered by L1 measurements of the CLTM target cell;
the electronic device is configured with user equipment (UE)-based TA measurement;
the electronic device has successfully measured a TA for the CLTM target cell;
the measured TA is valid in a first available CG occasion corresponding to the selected SSB or CSI-RS; and
in response to the third determination being affirmative:
processing the stored TA command associated with the ltm-Candidate-TimeAlignmentTimer; and
considering the RACH-less conditional LTM cell switch to be ongoing.

16. The electronic device of claim 15, wherein the selected SSB or CSI-RS is an SSB or CSI-RS for which the event was triggered.

17. The electronic device of claim 11, wherein the instructions, when executed by the at least one processor individually or collectively, further cause the electronic device to:
determine a third determination whether:
the event is triggered by layer 3 (L3) measurements of the CLTM target cell;
two TAGs are not configured for the CLTM target cell;
a CG Type 1 configuration for a RACH-less cell switch procedure is configured for the CLTM target cell; and
ltm-Candidate-TimeAlignmentTimer is running in a first CG occasion corresponding to a selected SSB and
in response to the third determination being affirmative:
process the stored TA command associated with the ltm-Candidate-TimeAlignmentTimer; and
consider the RACH-less conditional LTM cell switch to be ongoing.

18. The electronic device of claim 17, wherein the selected SSB is an SSB with a synchronization signal reference signal received power (SS-RSRP) above a threshold cg-LTM-RSRP-ThresholdSSB amongst a plurality of SSBs associated with the CG Type 1 configuration.

19. The electronic device of claim 11, wherein the instructions, when executed by the at least one processor individually or collectively, further cause the electronic device to:
determine a third determination whether:
the event is triggered by layer 3 (L3) measurements of the CLTM target cell;
two TAGs are configured for the CLTM target cell;
a CG Type 1 configuration for a random access channel (RACH)-less cell switch procedure is configured for the CLTM target cell; and
a first LTM candidate time alignment timer (ltm-Candidate-TimeAlignmentTimer) or a second LTM candidate time alignment timer (ltm-Candidate-TimeAlignmentTimerTAG2) of the CLTM target cell corresponding to a TAG associated with a transmission configuration indicator(TCI) state QCLed with the selected SSB or selected CSI-RS is running in a first available CG occasion corresponding to the selected SSB or SSB QCLed with the selected CSI-RS; and
in response to the third determination being affirmative:
process the stored TA command associated with the ltm-Candidate-TimeAlignmentTimer or the ltm-Candidate-TimeAlignmentTimerTAG2; and
consider the RACH-less conditional LTM cell switch to be ongoing.

20. The electronic device of claim 19, wherein the selected SSB is an SSB with a synchronization signal reference signal received power (SS-RSRP) above a threshold cg-LTM-RSRP-ThresholdSSB amongst a plurality of SSBs associated with the CG Type 1 configuration, and is associated with the TCI state of the TAG for which ltm-Candidate-TimeAlignmentTimer or ltm-Candidate-TimeAlignmentTimerTAG2 is running.
